(19) United States
(12) Patent Application Publication
(10) Pub. No.: US 2026/0039418 A1
(43) Pub. Date: Feb. 5, 2026

(54) TECHNIQUES FOR ADAPTIVE PACKET DATA CONVERGENCE PROTOCOL DUPLICATION

(71) Applicant: QUALCOMM Incorporated, San Diego, CA (US)

(72) Inventors: Sitaramanjaneyulu KANAMARLAPUDI, San Diego, CA (US); Ozcan OZTURK, San Diego, CA (US); Gavin Bernard HORN, La Jolla, CA (US)

(21) Appl. No.: 18/789,617

(22) Filed: Jul. 30, 2024

(51) Int. Cl. H04L 1/08

(52) U.S. Cl. CPC H04L 1/08

(57) ABSTRACT

Aspects of adaptive packet data convergence protocol duplication are described. In some examples, a user equipment (UE) may establish one or more communication links with a network entity, and each communication link may include a respective bearer. The UE may communicate, with the network entity, a first plurality of packets via the one or more communication links. The UE may monitor one or more metrics associated with the first plurality of packets. The UE may transmit, to the network entity, a message associated with configuration of PDCP duplication on the respective bearers of one or more of a second plurality of packets to be communicated via the one or more communication links.

### FIELD OF TECHNOLOGY

The following relates to wireless communications, including techniques for adaptive packet data convergence protocol duplication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include establishing one or more communication links with a network entity, where each communication link includes a respective bearer, communicating, with the network entity, a first set of multiple packets via the one or more communication links, monitoring one or more metrics associated with the first set of multiple packets, and transmitting, to the network entity, a message associated with configuration of packet data convergence protocol (PDCP) duplication on the respective bearers of one or more of a second set of multiple packets to be communicated via the one or more communication links, where the message is based on the one or more metrics.

A UE for wireless communication is described. The UE may include one or more memories storing processor executable code, and one or more processors coupled with the one or more memories. The one or more processors may individually or collectively be operable to execute the code to cause the UE to establish one or more communication links with a network entity, where each communication link includes a respective bearer, communicate, with the network entity, a first set of multiple packets via the one or more communication links, monitor one or more metrics associated with the first set of multiple packets, and transmit, to the network entity, a message associated with configuration of PDCP duplication on the respective bearers of one or more of a second set of multiple packets to be communicated via the one or more communication links, where the message is based on the one or more metrics.

Another UE for wireless communication is described. The UE may include means for establishing one or more communication links with a network entity, where each communication link includes a respective bearer, means for communicating, with the network entity, a first set of multiple packets via the one or more communication links, means for monitoring one or more metrics associated with the first set of multiple packets, and means for transmitting, to the network entity, a message associated with configuration of PDCP duplication on the respective bearers of one or more of a second set of multiple packets to be communicated via the one or more communication links, where the message is based on the one or more metrics.

A non-transitory computer-readable medium storing code for wireless communication is described. The code may include instructions executable by one or more processors to establish one or more communication links with a network entity, where each communication link includes a respective bearer, communicate, with the network entity, a first set of multiple packets via the one or more communication links, monitor one or more metrics associated with the first set of multiple packets, and transmit, to the network entity, a message associated with configuration of PDCP duplication on the respective bearers of one or more of a second set of multiple packets to be communicated via the one or more communication links, where the message is based on the one or more metrics.

Some examples of the method, user equipment (UEs), and non-transitory computer-readable medium described herein may further include operations, features, means, or instructions for inputting to a machine learning model the one or more metrics associated with the first set of multiple packets, where an output of the machine learning model includes an indication to enable, disable, or modify the duplication; and, where, transmitting the message, further comprises transmitting the message requesting to enable, disable, or modify the duplication based on the output of the machine learning model.

Some examples of the method, user equipment (UEs), and non-transitory computer-readable medium described herein may further include operations, features, means, or instructions for inputting to a machine learning model the one or more metrics associated with the first set of multiple packets, where the machine learning model provides an output related to the duplication and modifying a value for a reordering timer or a duplication percentage based on the output of the machine learning model.

In some examples of the method, user equipment (UEs), and non-transitory computer-readable medium described herein, monitoring the one or more metrics may include operations, features, means, or instructions for determining whether to enable, disable, or modify the duplication based on the one or more metrics, where the one or more metrics include at least one of a packet error based metric or packet latency based metric.

In some examples of the method, user equipment (UEs), and non-transitory computer-readable medium described herein, transmitting the message may include operations, features, means, or instructions for transmitting the message requesting to enable, disable, or modify the duplication based on the one or more metrics, where the one or more metrics include at least one of a packet error associated with a reordering window or a recovery latency associated with the reordering window.

In some examples of the method, user equipment (UEs), and non-transitory computer-readable medium described herein, transmitting the message may include operations, features, means, or instructions for transmitting the message indicating a quantity of duplicated packets of the first set of multiple packets, a quantity of out of window (OOW) packets of the first set of multiple packets, or both.

In some examples of the method, user equipment (UEs), and non-transitory computer-readable medium described herein, the message may be transmitted periodically.

In some examples of the method, user equipment (UEs), and non-transitory computer-readable medium described herein, the one or more communication links include a set of multiple communication links and the message indicates to duplicate the one or more of the second set of multiple packets across the respective bearers of the set of multiple communication links.

In some examples of the method, user equipment (UEs), and non-transitory computer-readable medium described herein, the message may be transmitted based on an event associated with the duplication.

Some examples of the method, user equipment (UEs), and non-transitory computer-readable medium described herein may further include operations, features, means, or instructions for transmitting, to the network entity, control signaling requesting reordering window statistics associated with the first set of multiple packets, where the reordering window statistics include at least one of a quantity of reorder timer starts, a quantity of duplicated packets, or a quantity of out OOW packets.

In some examples of the method, user equipment (UEs), and non-transitory computer-readable medium described herein, the one or more metrics include at least one of a quantity of duplicated packets associated with the first set of multiple packets, a quantity of OOW packets associated with the first set of multiple packets, a quantity of reordering timer starts associated with the first set of multiple packets.

In some examples of the method, user equipment (UEs), and non-transitory computer-readable medium described herein, the one or more metrics include at least one of a hybrid automatic repeat request block error rate associated with the first set of multiple packets, a radio link control automatic repeat request block error rate associated with the first set of multiple packets, a quality of service characteristic associated with the first set of multiple packets, or a delay budget associated with the first set of multiple packets.

In some examples of the method, user equipment (UEs), and non-transitory computer-readable medium described herein, the one or more metrics include at least one of a requirement associated with a packet data unit set budget delay, a packet data unit set error rate, or packet data unit set integrated handling information.

In some examples of the method, user equipment (UEs), and non-transitory computer-readable medium described herein, the one or more metrics include a power metric associated with the first set of multiple packets and the power metric may be associated with a duty cycle.

In some examples of the method, user equipment (UEs), and non-transitory computer-readable medium described herein, the one or more metrics include at least one of a quantity of duplicated packets communicated via one of the one or more communication links, or a quantity of OOW packets of the one of the one or more communication links.

A method for wireless communication by a network entity is described. The method may include establishing one or more communication links with a UE, where each communication link includes a respective bearer, communicating, with the UE, a first set of multiple packets via the one or more communication links, and obtaining, from the UE, a message associated with configuration of PDCP duplication on the respective bearers of one or more of a second set of multiple packets to be communicated via the one or more communication links.

A network entity for wireless communication is described. The network entity may include one or more memories storing processor executable code, and one or more processors coupled with the one or more memories. The one or more processors may individually or collectively be operable to execute the code to cause the network entity to establish one or more communication links with a UE, where each communication link includes a respective bearer, communicate, with the UE, a first set of multiple packets via the one or more communication links, and obtain, from the UE, a message associated with configuration of PDCP duplication on the respective bearers of one or more of a second set of multiple packets to be communicated via the one or more communication links.

Another network entity for wireless communication is described. The network entity may include means for establishing one or more communication links with a UE, where each communication link includes a respective bearer, means for communicating, with the UE, a first set of multiple packets via the one or more communication links, and means for obtaining, from the UE, a message associated with configuration of PDCP duplication on the respective bearers of one or more of a second set of multiple packets to be communicated via the one or more communication links.

A non-transitory computer-readable medium storing code for wireless communication is described. The code may include instructions executable by one or more processors to establish one or more communication links with a UE, where each communication link includes a respective bearer, communicate, with the UE, a first set of multiple packets via the one or more communication links, and obtain, from the UE, a message associated with configuration of PDCP duplication on the respective bearers of one or more of a second set of multiple packets to be communicated via the one or more communication links.

Some examples of the method, network entities, and non-transitory computer-readable medium described herein may further include operations, features, means, or instructions for inputting to a machine learning model one or more metrics associated with the first set of multiple packets, where an output of the machine learning model includes an indicator to enable, disable, or modify the duplication.

Some examples of the method, network entities, and non-transitory

computer-readable medium described herein may further include operations, features, means, or instructions for inputting to a machine learning model one or more metrics associated with the first set of multiple packets, where the machine learning model provides an output related to the duplication and scheduling the second set of multiple packets based on the output of the machine learning model.

In some examples of the method, network entities, and non-transitory computer-readable medium described herein, obtaining the message may include operations, features, means, or instructions for obtaining the message indicating that the UE enables, disables, or modifies the duplication based on at least one of a packet error based metric or a packet latency based metric.

In some examples of the method, network entities, and non-transitory computer-readable medium described herein, obtaining the message may include operations, features, means, or instructions for obtaining the message requesting to enable, disable, or modify the duplication based on at least one of a packet error associated with a reordering window of the UE or a recovery latency associated with a reordering window of the UE.

In some examples of the method, network entities, and non-transitory computer-readable medium described herein, obtaining the message may include operations, features, means, or instructions for obtaining the message indicating a quantity of duplicated packets associated with the first set of multiple packets, a quantity of OOW packets associated with the first set of multiple packets, or both.

Some examples of the method, network entities, and non-transitory computer-readable medium described herein may further include operations, features, means, or instructions for scheduling the second set of multiple packets based on the message.

Some examples of the method, network entities, and non-transitory computer-readable medium described herein may further include operations, features, means, or instructions for obtaining, from the UE, control signaling requesting reordering window statistics associated with the first set of multiple packets, where the reordering window statistics include at least one of a quantity of reorder timer starts associated with the first set of multiple packets, a quantity of duplicated packets associated with the first set of multiple packets, or a quantity of OOW packets associated with the first set of multiple packets.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for adaptive packet data convergence protocol (PDCP) duplication in accordance with one or more aspects of the present disclosure.

FIG. 2 shows an example of a wireless communications system that supports techniques for adaptive PDCP duplication in accordance with one or more aspects of the present disclosure.

FIG. 3 shows an example of a process flow that supports techniques for adaptive PDCP duplication in accordance with one or more aspects of the present disclosure.

FIGS. 4 and 5 show block diagrams of devices that support techniques for adaptive PDCP duplication in accordance with one or more aspects of the present disclosure.

FIG. 6 shows a block diagram of a communications manager that supports techniques for adaptive PDCP duplication in accordance with one or more aspects of the present disclosure.

FIG. 7 shows a diagram of a system including a device that supports techniques for adaptive PDCP duplication in accordance with one or more aspects of the present disclosure.

FIGS. 8 and 9 show block diagrams of devices that support techniques for adaptive PDCP duplication in accordance with one or more aspects of the present disclosure.

FIG. 10 shows a block diagram of a communications manager that supports techniques for adaptive PDCP duplication in accordance with one or more aspects of the present disclosure.

FIG. 11 shows a diagram of a system including a device that supports techniques for adaptive PDCP duplication in accordance with one or more aspects of the present disclosure.

FIGS. 12 through 15 show flowcharts illustrating methods that support techniques for adaptive PDCP duplication in accordance with one or more aspects of the present disclosure.

### DETAILED DESCRIPTION

In some wireless communications systems, a transmitting wireless communication device, such as a user equipment (UE) or a network entity, may implement packet data convergence protocol (PDCP) duplication. PDCP duplication may be configured and enabled to improve latency or reliability based on the traffic characteristics. The transmitting wireless communication device may transmit duplicate packet data units (PDUs) over different radio link control (RLC) legs to a receiving wireless communication device. From the receiving wireless communication device perspective, the duplicate PDUs may help rapid recovery of lost PDUs; however, if the receiving wireless communication device successfully received the PDUs, the duplicate PDUs are discarded and may waste resources. In some cases, the receiving wireless communication device may discard out of window (OOW) PDUs that may waste resources. In some examples, the network entity may enable the duplication and the percentage of duplication from the UE or the duplication and percentage of duplication by the network entity. In some cases, network entity may not be aware of the quantity of discarded PDUs and may not be able to adapt the duplication based on the quantity of discarded PDUs. As such, approaches for adaptive PDCP duplication may be desirable.

Aspects described herein are directed to techniques for adaptive PDCP duplication. For example, a UE may establish one or more communication links with a network entity, and each communication link may include an associated RLC entity (e.g., and a separate bearer). The UE may communicate, with the network entity 105, a first plurality of packets via the one or more communication links. The UE may monitor one or more metrics (e.g., evaluate metrics or feed metrics into a machine learning (ML) instance) associated with the first plurality of packets. The UE may transmit, to the network entity, a message or feedback message associated with configuration of PDCP duplication of one or more of a second plurality of packets to be communicated via the one or more communication links. In some cases, the UE may determine to enable, disable or modify the duplication based on packet error based metrics or latency metrics. In some examples, the UE may transmit the message that includes a request to enable, disable, or modify the duplication based on packet error based metrics or latency metrics. In some cases, the message may report a quantity of OOW packets, a quantity of duplicated packets, or both. In some examples, the metric associated with the first plurality of packets may be a quantity of reorder timer starts, a quantity of OOW packets, or a quantity of packets duplicated. In some cases, the one or more metrics associated with the first plurality of packets may be input to a ML model that provides an output related to the duplication.

Aspects of the disclosure are initially described in the context of wireless communications systems. Aspects of the disclosure are additionally described in the context of a process flow diagram. Aspects of the disclosure are further illustrated by and described with reference to apparatus diagrams, system diagrams, and flowcharts that relate to techniques for adaptive PDCP duplication.

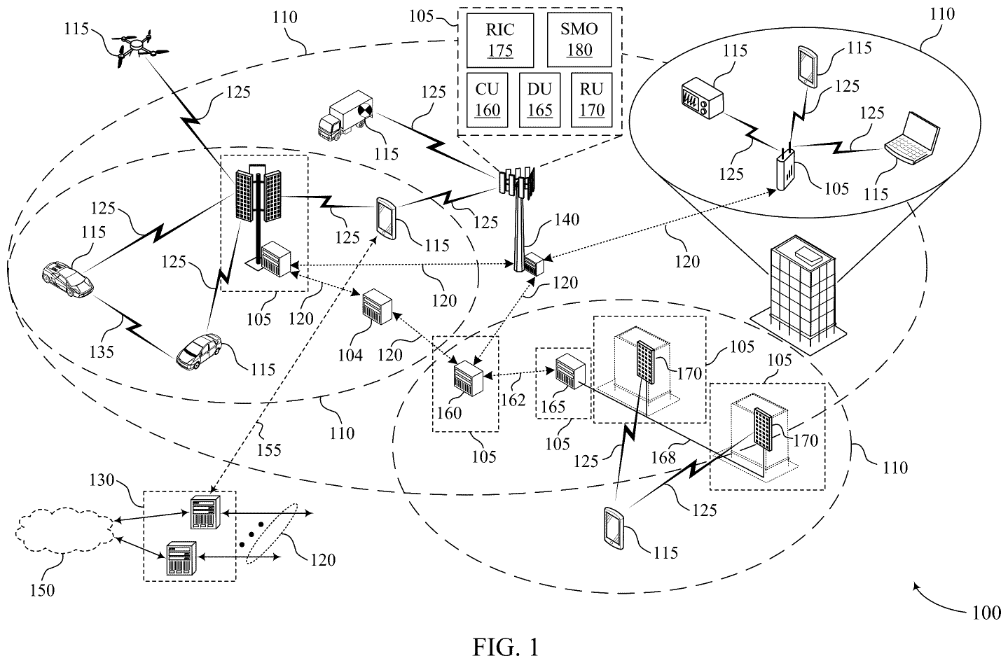

FIG. 1 shows an example of a wireless communications system 100 that supports techniques for adaptive PDCP duplication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques for adaptive PDCP duplication may be employed. For example, a UE 115 may establish one or more communication links with a network entity 105, and each communication link may include an associated RLC entity (e.g., and a separate bearer). The UE 115 may communicate, with the network entity 105, a first plurality of packets via the one or more communication links. The UE 115 may monitor one or more metrics (e.g., evaluate metrics or feed metrics into a ML instance) associated with the first plurality of packets. The UE 115 may transmit, to the network entity 105, a message or feedback message associated with configuration of PDCP duplication via the one or more communication links. In some cases, the UE 115 may determine to enable, disable or modify the duplication based on packet error based metrics or latency metrics. In some examples, the UE 115 may transmit the message that includes a request to enable, disable or modify the duplication based on packet error based metrics or latency metrics. In some cases, the message may report a quantity of OOW packets, a quantity of duplicated packets, or both. In some examples, the metric associated with the first plurality of packets may be a quantity of reorder timer starts, a quantity of OOW packets, or a quantity of packets duplicated. In some cases, the one or more metrics associated with the first plurality of packets may be input to a ML model that provides an output related to the duplication.

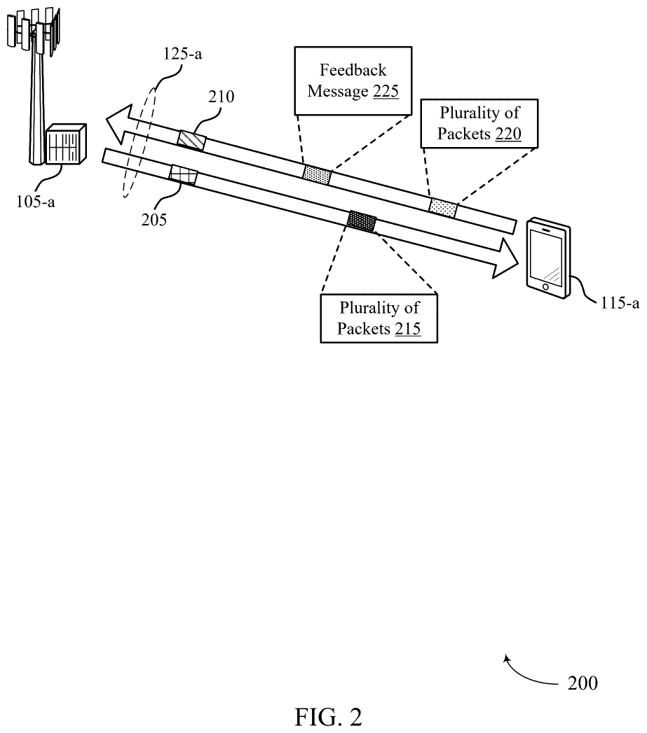

FIG. 2 shows an example of a wireless communications system 200 that supports techniques for adaptive PDCP duplication in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of a 6th generation (6G), a NR or LTE link between the UE 115-a and the network entity 105-a. The communication link 125-a may include bi-directional links that enable both uplink and downlink communications. For example, the network entity 105-a may transmit downlink signals (e.g., downlink transmissions 205), such as downlink control signaling and downlink data signals, to the UE 115-a using the communication link 125-a, and the UE 115-a may transmit uplink signals (e.g., uplink transmissions 210), such as uplink control signaling and uplink data signals, to the network entity 105-a using the communication link 125-a.

The UE 115-a may establish one or more communication links (e.g., via the communication link 125-a) with the network entity 105-a, and each communication link may include an associated RLC entity (e.g., and a separate bearer). The UE 115-a may receive, from the network entity 105-a, a plurality of packets 215, and the UE 115-a may transmit, to the network entity 105-a, a plurality of packets 220. In some cases, the transmitting wireless device (e.g., the UE 115-a and the network entity 105-a) may implement PDCP duplication. PDCP duplication may be configured and enabled from the transmitter perspective to improve the latency or reliability based on the traffic characteristics. Duplicate PDUs may be transmitted over different RLC legs in the same radio access technology (RAT) or across two different RAT RLC legs (e.g., Multi-RAT Dual Connectivity (MR-DC) or Evolved Non-standalone Dual Connectivity (EN-DC)). From the receiver perspective, duplicate PDUs may help rapid recovery of lost PDUs; however, if the receiving wireless communication device successfully received the PDUs, the duplicate PDUs are discarded and may waste resources, such as channel, decoding, processing, memory and sleep cycle awake. In some cases, the receiving wireless communication device may discard OOW PDUs that may waste resources. Duc to duplication or a reordering timer (t-Reordering) expiry, PDCP processing may move the processing window to the right in time. PDCP PDUs received that are positioned left of the window are dropped as OOW PDUs. The OOW PDUs may be a result of delays in scheduling or reliable reception across the duplicate legs in the receive path.

In some examples, PDCP PDUs are duplicated based on a configuration provided by the network entity 105-a to the UE 115-a through resource block (RB) configuration parameters. PDCP OOW PDUs may be discarded based on a PDCP window management configuration. In some cases, a large quantity of PDUs may be discarded due to the configurations; however, the transmitting entity (e.g., network entity 105-a or UE 115-a) may not be aware of the quantity of discarded PDUs and may not be able to adapt the duplication or scheduling based on the quantity of discarded PDUs to improve the radio resource management aspects.

In some cases, UE behavior regarding PDU duplication may be achieved at a cost of flexibility. For example, the network entity 105-a may control the PDU duplication for the UE 115-a or the network entity 105-a. The network entity 105-a may derive information related to the quantity of discarded PDUs indirectly based on a hybrid automatic repeat request block error rate (HARQ BLER) or a RLC automatic repeat request block error rate (ARQ BLER) to enable, disable, increase, or decrease the duplication. In some cases, the network entity may derive the OOW situation indirectly based on the PDCP sequence number (SN) scheduling delays across the legs in MR-DC or EN-DC configuration with distributed unit (DU) level coordination and Xn interface based messaging with respect to the configured reordering timer.

In some examples, techniques for adaptive PDCP duplication may be employed. For example, in some cases, the UE 115-a may initiate a request to the network entity 105-a for PDCP duplication enablement, disablement, or modification. In some cases, the UE 115-a may transmit, to the network entity 105-a, PDCP status or MAC-CE based report of discarded packets and OOW packets periodically or event based (e.g., remaining reordering timer being less than a threshold or a quantity of PDUs in memory being above a threshold) for the downlink PDCP traffic or bearer.

In some examples, the UE 115-a may not directly modify the PDCP duplication process. For example, the PDCP reordering window management may be performed based on an in-sequence arrival of PDUs or based on the reordering timer expiry. Any PDUs which are received as duplicate are discarded and any PDUs associated with a SN earlier than the left edge of the window are discarded as OOW PDUs. In some cases, the UE 115-a may not enable autonomously the PDCP duplication based on the HARQ BLER or RLC ARQ BLER logistics or modify split-threshold traffic steering for better traffic reliability or an improved latency key performance indicator (KPI) from uplink perspective. In some cases, the UE 115-a may not request the network entity 105-a for duplication or modification of the duplication percentage based on UE reception metrics, and the UE 115-a may not have a mechanism to indicate the OOW packets statistics to the network entity 105-a to improve the network scheduling by switching, splitting, or steering the traffic.

In some cases, techniques for adaptive PDCP duplication may be employed. For example, the network entity 105-a may configure the UE 115-a with a flexible procedure based on the UE 115-a monitoring metrics related to the PDU duplication and derived from artificial intelligence (AI) or ML models. In some examples, the techniques for adaptive PDCP duplication may provide flexible handling of the UE uplink PDCP to determine to enable, disable, or modify the UE duplication (and percentage) based on HARQ BLER, RLC ARQ BLER packet error based metrics. In some examples, the techniques for adaptive PDCP duplication may provide flexible handling of the UE uplink PDCP to determine to enable, disable, or modify the UE duplication (and percentage) based on HARQ BLER or RLC ARQ BLER in terms of latency metrics. In some cases, the UE 115-a may transmit a request to the network entity 105-a for downlink PDCP duplication (and percentage) based on the HARQ, RLC ARQ packet error impacting the PDCP reordering window. In some cases, the UE 115-a may transmit a request to the network entity 105-a for downlink PDCP duplication (and percentage) based on the HARQ or RLC level recovery latency impacting the PDCP reordering window. In some cases, the PDCP duplicated and OOW packets count may be transmitted from the receiver to the transmitter to adapt duplication dynamically, resulting in improved scheduling aspects impacting radio resource management as well as power KPIs (e.g., network entity 105-a power saving as well as UE 115-a power saving) based on error rate, latency metrics, or sleep cycle patterns. In some cases, flexible reporting for specific types of traffic based on QoS requirements (e.g., PDU level or PDU set level) for given bearer or PDU session may be implemented.

In some examples, techniques for adaptive PDCP duplication may include the UE 115-a monitoring one or more metrics associated with the plurality of packets (e.g., the plurality of packets 215 and the plurality of packets 220) and transmitting a message 225 or feedback message associated with configuration of PDCP duplication. The feedback message may request enabling, disabling, or modification of the PDCP duplication. The feedback message may include metrics associated with the packets (e.g., the plurality of packets 215 and the plurality of packets 220). In some cases, the UE 115-a may determine and influence the PDU duplication and scheduling delays through modifying the duplication configuration or duplication pattern as well as scheduling patterns in both in uplink (e.g., internal to the UE 115-a) or downlink (e.g., requesting network entity 105-a to enable, disable, or modify duplication). The UE 115-a may influence the PDU duplication by evaluating the PDCP duplication and OOW PDUs metrics or by reporting the PDCP duplication and OOW PDUs metrics to the network entity 105-a.

In some cases, the UE 115-a may implement flexible procedures for the PDCP reordering window functionality. For uplink PDCP, the UE 115-a may determine to enable, disable, or modify UE duplication (and percentage) based on HARQ BLER or RLC ARQ BLER packet error based metrics. If the BLER characteristics indicate good channel conditions and no HARQ level retransmissions or lower residual BLER at HARQ level, the UE 115-a may determine that PDCP duplication across the RLC entities may be disabled or decreased. If the BLER characteristics indicate poor channel conditions specific to a main cell group (MCG) or secondary cell group (SCG), the UE 115-a may determine that PDCP duplication across the RLC entities may be enabled or increased. If the HARQ BLER is high and specific to one component carrier (CC) or slot, the UE 115-a may determine that PDCP duplication may be enabled or increased within one RLC entity.

In some cases, for uplink PDCP, the UE 115-a may determine to enable, disable, or modify UE duplication (e.g., and percentage) based on HARQ BLER or RLC ARQ BLER in terms of the latency metrics. If the latency is high on a specific RLC entity due to variation in the scheduling pattern, such as the MCG primary cell being loaded while the SCG is not loaded and higher scheduling (e.g., higher requests for resources), some level of duplication may be used to ensure window movement is not stalled. If the latency is high on a specific CC or slot due to high BLER and large quantity of HARQ retransmissions, some level of duplication may be used.

For uplink PDCP with the UE 115-a determining to enable, disable, or modify UE duplication (e.g., and percentage) based on HARQ BLER or RLC ARQ BLER in terms of the packet error based metrics or the latency metrics, the UE may monitor these metrics, and, based on the HARQ or RLC ARQ and associated delays with respect to scheduling from the PDCP transmission (Tx) perspective (e.g., based on RLC Tx window movement), the UE 115-a may train the AI or ML based model to enable the duplication dynamically (e.g., or percentage) across RLC entities or within one RLC entity. The duplication may be based on the flow specific traffic pattern (e.g., bursty, periodic, peak-to-average) as well as quality of service (QOS) requirements specific to flows and different flows multiplexed on the given radio bearer. In some cases, the duplication may be PDU set specific, such as for extended reality (XR) applications, to satisfy the PDU set oriented traffic (e.g., PDU set delay budget (PSDB), PDU set error rate (PSER), PDU set importance (PSI), and PDU set integrated handling indication (PSIHI) aspects of the XR applications).

In some cases, the UE 115-a may transmit, to the network entity 105-a, a request for downlink duplication (e.g., and percentage) based on the HARQ or RLC ARQ packet error impacting the reordering window. The UE 115-a may monitor the quantity of packets received as duplicate across the RLC entities or within one RLC entity, and the UE 115-a may monitor the quantity of holes seen at PDCP reordering level with the varying HARQ BLER and RLC ARQ related retransmissions. Based on monitoring the metrics, UE 115-a may transmit, to the network entity, the request for the duplication (e.g., and percentage) dynamically through PDCP, RLC, or MAC-CE.

In some cases, the UE 115-a may transmit, to the network entity 105-a, a request for downlink duplication (e.g., and percentage) based on the HARQ or RLC level recovery latency impacting reordering window. In some examples, the latency impacting the reordering window may be based on the type of delays at the PDCP reordering window management level, with or without-reordering timer expiry, due to scheduling latency between the PDUs coming through different RLC entities with respect to delay requirements of the flows across the QoS identifiers mapped on the bearer.

In some examples, the UE 115-a may transmit, to the network entity 105-a, a report indicating the PDCP duplicated and OOW packets count from the receiver to the transmitter to adapt the duplication. By adapting the duplication, the scheduling aspects impacting radio resource management, or the power KPI (e.g., network entity 105-a power saving and UE 115-a power saving) based on error rate, latency metrics or sleep cycle patterns may be improved. The report indicating the PDCP duplication and OOW packets count may be useful for the internal UE logistics in handling the traffic as sometimes the packets might be discarded at PDCP level though seen as successfully received at RLC level due to various implementation reasons of network entity 105-a or UE 115-a. For example, when the scheduling delays are high on a specific leg (e.g., FR1 vs FR2), although an RLC ACK may be received by the network entity 105-a, the UE 115-a may discard the PDU at PDCP as UE 115-a may move on the lower edge of the reordering window due to reordering timer expiry or due to a memory based flush to move the window.

In some cases, the UE 115-a may transmit, to the network entity 105-a, a request to enable or modify the network configuration to report the PDCP metrics based on the following techniques through RRC, such as UE assistance information (UAI), PDCP Control PDU, or MAC-CE. The reporting to the network entity 105-a or modification to the UE 115-a may be specific to one RB, a group of RBs, or PDU session specific when reported through RRC signaling, and the report may be logical channel (LG) or logical channel group (LCG) specific when reported through MAC-CE based signaling. The reporting to the network entity 105-a or modification of UE behavior may be specific to a RB, a PDU Session, or a slice of the PDU session considering the QoS requirements of the traffic mapped or active on the bearer or based on the configured or active PDU Set characteristics. In some cases, requesting the network entity 105-a to report uplink PDCP reordering window statistics for UE based dynamic behavior or UE indicating downlink statistics for uplink dynamic behavior may be done through RRC, PDCP, or MAC level using standard control messaging or control element approaches. The granularity of this procedure may be bearer, PDU session, LCG level, slice, or UE specific through signaling at MAC, PDCP, or RRC mechanisms. In some cases, new PDCP reordering statistics information may be defined, such as a new information element, that configures reordering statistics reporting for uplink or downlink including reordering timer information, reordering duplication count information, reordering OOW count information, and reordering integrity fail count information.

In some cases, the UE 115-a may monitor PDCP reordering window KPI metrics. For example, the metric may be a quantity of PDCP duplicated PDUs at each level (e.g., bearer, PDU session, slice, or overall UE). The metric may be a quantity of PDCP OOW PDUs at each level (e.g., bearer, PDU session, slice, or overall UE). The metric may be a quantity of reordering timer starts, though not expired, indicating the latency impact at each level. The metric may be a quantity of RLC ARQ and HARQ BLER statistics impacting the reordering window for a specific bearer. In some cases, the BLER impacting a default bearer may not have much impact as compared to XR service based dedicated bearer, due to various scheduling decisions at the network entity 105-a, for example, higher spectral efficiency for default bearer traffic versus higher reliability for dedicated bearer traffic in MAC transport block (TB) or HARQ Tx. The metric may be QoS characteristics of the flow and associated delay budget or error rate versus the PDCP reordering behavior to align the configuration requirements (e.g., the quantity of times the PDCP was delivered or flow level discarded due to jitter management). The metric may be PDU set specific requirements to meet the PSDB, PSER, PSIHI or congestion specific impact on the window resulting in the higher duplication and OOW adjustments. The metric may be an impact associate with the higher or lower duplication on the power KPIs due to more discontinuous reception (DRX) ON duration versus OFF duration and associated impact with the higher duty cycle of an application. The metric may be duplicated or OOW PDUs statistics across different cells to understand the loading, bandwidth, or band specific characteristics to influence the conditional handover (CHO) or lower-layer triggered mobility (LTM) aspects in preparing candidate cells or executing specific cell handover (HO) execution during connected mode, or influencing the hysteresis of cell reselection during idle mode, for better user plane experience.

In some examples, the UE 115-a may use the monitored metrics associated with the plurality of packets to train the AI or ML model(s). In some cases, the metrics may be input to the AI or ML model, and the output of the AI or ML model may be an indication to enable, disable, or modify the duplication. In some cases, the output of the AI or ML model may be a value for a reordering timer or a duplication percentage. In some cases, the metrics and KPIs may be used for training the AI or ML model at the UE 115-a to refine the UE based PDCP Duplication procedures. In some cases, the metrics and KPIs may be reported to network entity 105-for AI or ML model training to choose the duplication configuration in downlink. Based on the AI or ML model and duplication or OOW counts, the UE 115-a may autonomously choose different values for the reordering timers or duplication percentage across and within same RLC entity to meet QoS (e.g., QoS for PDU or PDU Set), specific delay budget, error rate, integrity requirements during regular and congestion state of the radio or network for improved UE throughput, power and latency KPIs.

In some cases, the metrics may be used by the AI or ML model to improve scheduling aspects. For example, the UE 115-a may autonomously influence C-plane (e.g., control signaling) procedures based on the U-plane (e.g., user data) metrics, for specific connected mode handover procedures, such as preparing candidate cells in LTM, favoring different cells in CHO, or the criteria for cell reselection in idle mode. The network entity 105-a may influence the decision to handover using the metrics to balance the load both from throughput and latency perspective (EN-DC, NR-DC, Coverage vs Capacity Cells) to meet QoS requirements of the service active on the user plane.

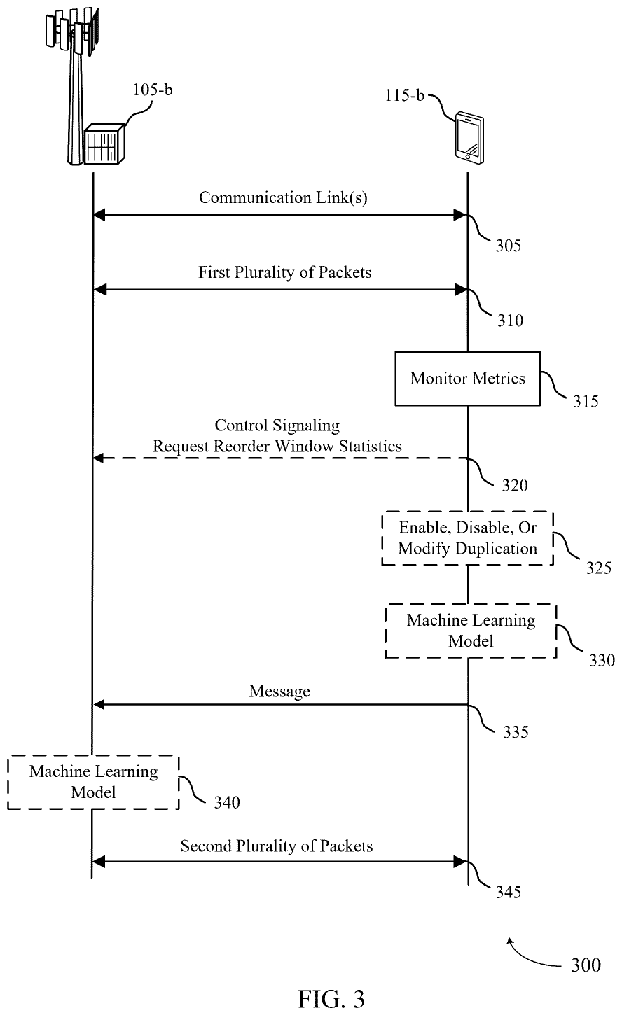

FIG. 3 shows an example of a process flow 300 that supports techniques for adaptive PDCP duplication in accordance with one or more aspects of the present disclosure. In some examples, the process flow 300 may implement or be implemented by aspects of the wireless communications systems 100 and 200 as described with reference to FIGS. 1 and 2, respectively. For example, the process flow 300 may be implemented by a network entity 105-b, which may be an example of the network entities 105 as described with reference to FIGS. 1 and 2. The process flow 300 may be implemented by a UE 115-b, which may be an example of the UEs as described with reference to FIGS. 1 and 2.

In some examples, the operations illustrated in the process flow 300 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 305, the UE 115-b may establish one or more communication links with the network entity 105-b, and each communication link may include a respective bearer.

At 310, the UE 115-b may communicate, with the network entity 105-b, a first plurality of packets via the one or more communication links.

At 315, the UE 115-b may monitor one or more metrics associated with the first plurality of packets. In some examples, the one or more metrics may be a quantity of duplicated packets associated with the first plurality of packets. In some examples, the one or more metrics may be a quantity of OOW packets associated with the first plurality of packets. In some examples, the one or more metrics may be a quantity of reordering timer starts associated with the first plurality of packets. In some examples, the one or more metrics may be a HARQ BLER associated with the first plurality of packets or a RLC ARQ BLER associated with the first plurality of packets. In some examples, the one or more metrics may be a QoS characteristic associated with the first plurality of packets or a delay budget associated with the first plurality of packets. In some examples, the one or more metrics may be a requirement associated with a PDU set budget delay, a PDU set error rate, or PDU set integrated handling information. In some examples, the one or more metrics may include a power metric associated with the first plurality of packets, and the power metric may be associated with a duty cycle. In some examples, the one or more metrics may be a quantity of duplicated packets communicated via one of the one or more communication links, or a quantity of OOW packets of the one of the one or more communication links.

At 320, the UE 115-b may transmit, to the network entity 105-b, control signaling requesting reordering window statistics associated with the first plurality of packets, and the reordering window statistics may include a quantity of reordering timer starts, a quantity of duplicated packets, or a quantity of OOW packets.

At 325, the UE 115-b may determine whether to enable, disable, or modify duplication via the respective bearers of one or more of a second plurality of packets to be communicated via the one or more communication links based at least in part on the one or more metrics. The one or more metrics may be a packet error based metric. The one or more metrics may be a packet latency based metric.

At 330, the UE 115-b may input to a ML model the one or more metrics associated with the first plurality of packets, and an output of the ML model may include an indication to enable, disable, or modify the duplication. In some examples, the output of the ML model may provide an output related to the duplication, and the UE 115-b may modify a value for a reordering timer or a duplication percentage based on the output of the ML model.

At 335, the UE 115-b may transmit, to the network entity 105-b, a message associated with configuration of PDCP duplication on the respective bearers of one or more of a second plurality of packets to be communicated via the one or more communication links. The message may be based on the one or more metrics. In some examples, the message may request to enable, disable, or modify the duplication based on the one or more metrics, and the one or more metrics may be a packet error associated with a reordering window. In some examples, the message may request to enable, disable, or modify the duplication based on the one or more metrics, and the one or more metrics may be a recovery latency associated with a reordering window. In some examples, the message may indicate a quantity of duplicated packets of the first plurality of packets, a quantity of OOW packets of the first plurality of packets, or both. In some examples, the message may be transmitted periodically. In some examples, the feedback message may indicate to duplicate the one or more of the second plurality of packets across the respective bearers of the plurality of communication links. In some examples, the message may be transmitted based on an event associated with the duplication.

At 340, the network entity 105-b may input to a ML model the one or more metrics associated with the first plurality of packets, where an output of the ML model may include an indication to enable, disable, or modify the duplication. In some examples, the output of the ML model may provide an output related to the duplication.

At 345, the network entity 105-b may schedule the second plurality of packets based on the message. In some examples, the network entity 105-b may schedule the second plurality of packets based on the output of the ML model. The network entity 105-b and the UE 115-b may communicate the second plurality of packets.

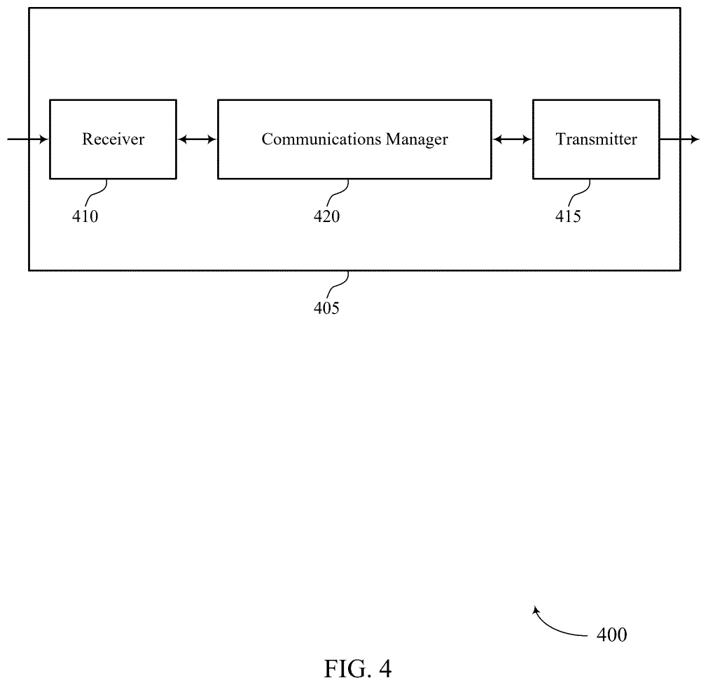

FIG. 4 shows a block diagram 400 of a device 405 that supports techniques for adaptive PDCP duplication in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for adaptive PDCP duplication). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for adaptive PDCP duplication). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for adaptive PDCP duplication as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for establishing one or more communication links with a network entity, where each communication link includes a respective bearer. The communications manager 420 is capable of, configured to, or operable to support a means for communicating, with the network entity, a first set of multiple packets via the one or more communication links. The communications manager 420 is capable of, configured to, or operable to support a means for monitoring one or more metrics associated with the first set of multiple packets. The communications manager 420 is capable of, configured to, or operable to support a means for transmitting, to the network entity, a message associated with configuration of PDCP duplication on the respective bearers of one or more of a second set of multiple packets to be communicated via the one or more communication links, where the message is based on the one or more metrics.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

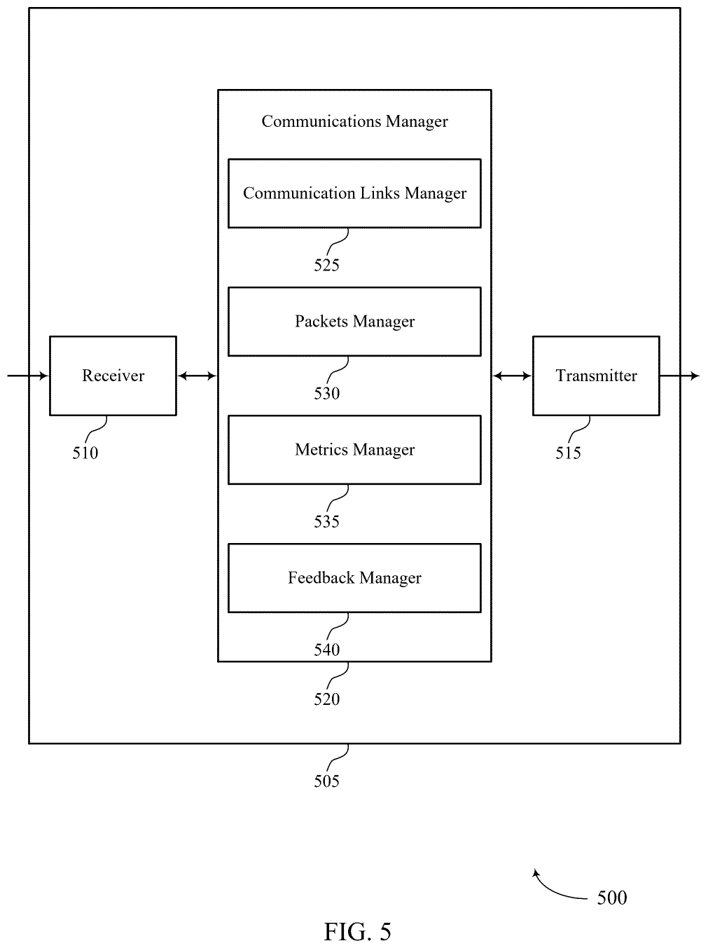

FIG. 5 shows a block diagram 500 of a device 505 that supports techniques for adaptive PDCP duplication in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for adaptive PDCP duplication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for adaptive PDCP duplication). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for adaptive PDCP duplication as described herein. For example, the communications manager 520 may include a communication links manager 525, a packets manager 530, a metrics manager 535, a feedback manager 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The communication links manager 525 is capable of, configured to, or operable to support a means for establishing one or more communication links with a network entity, where each communication link includes a respective bearer. The packets manager 530 is capable of, configured to, or operable to support a means for communicating, with the network entity, a first set of multiple packets via the one or more communication links. The metrics manager 535 is capable of, configured to, or operable to support a means for monitoring one or more metrics associated with the first set of multiple packets. The feedback manager 540 is capable of, configured to, or operable to support a means for transmitting, to the network entity, a message associated with configuration of PDCP duplication on the respective bearers of one or more of a second set of multiple packets to be communicated via the one or more communication links, where the message is based on the one or more metrics.

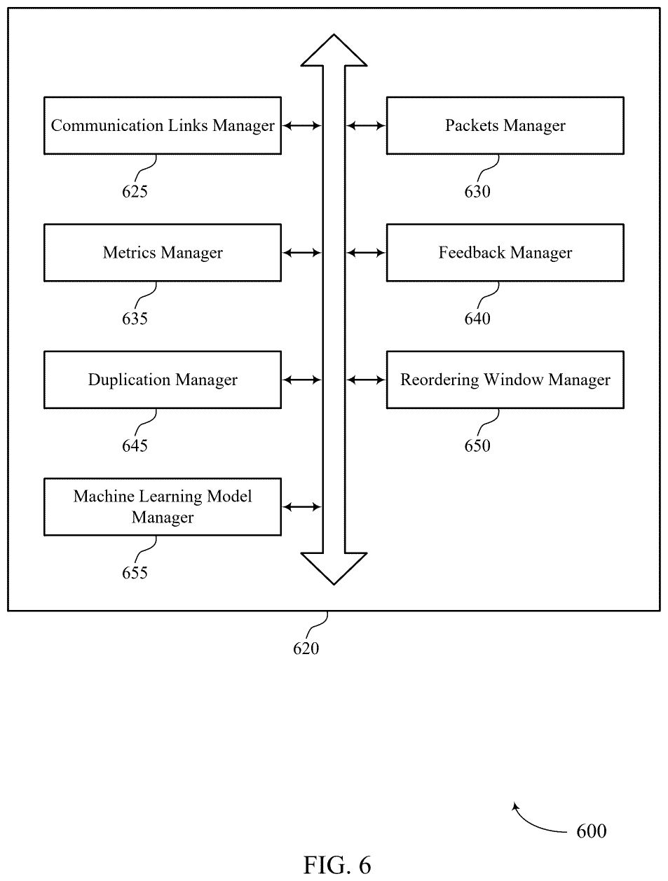

FIG. 6 shows a block diagram 600 of a communications manager 620 that supports techniques for adaptive PDCP duplication in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for adaptive PDCP duplication as described herein. For example, the communications manager 620 may include a communication links manager 625, a packets manager 630, a metrics manager 635, a feedback manager 640, a duplication manager 645, a reordering window manager 650, a machine learning model manager 655, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The communication links manager 625 is capable of, configured to, or operable to support a means for establishing one or more communication links with a network entity, where each communication link includes a respective bearer. The packets manager 630 is capable of, configured to, or operable to support a means for communicating, with the network entity, a first set of multiple packets via the one or more communication links. The metrics manager 635 is capable of, configured to, or operable to support a means for monitoring one or more metrics associated with the first set of multiple packets. The feedback manager 640 is capable of, configured to, or operable to support a means for transmitting, to the network entity, a message associated with configuration of PDCP duplication on the respective bearers of one or more of a second set of multiple packets to be communicated via the one or more communication links, where the message is based on the one or more metrics.

In some examples, to support monitoring the one or more metrics, the duplication manager 645 is capable of, configured to, or operable to support a means for determining whether to enable, disable, or modify the duplication based on the one or more metrics, where the one or more metrics include at least one of a packet error based metric or packet latency based metric.

In some examples, to support transmitting the message, the feedback manager 640 is capable of, configured to, or operable to support a means for transmitting the message requesting to enable, disable, or modify the duplication based on the one or more metrics, where the one or more metrics include at least one of a packet error associated with a reordering window or a recovery latency associated with the reordering window.

In some examples, to support transmitting the message, the feedback manager 640 is capable of, configured to, or operable to support a means for transmitting the message indicating a quantity of duplicated packets of the first set of multiple packets, a quantity of out of window packets of the first set of multiple packets, or both.

In some examples, the message is transmitted periodically.

In some examples, the one or more communication links include a set of multiple communication links. In some examples, the message indicates to duplicate the one or more of the second set of multiple packets across the respective bearers of the set of multiple communication links.

In some examples, the message is transmitted based on an event associated with the duplication.

In some examples, the reordering window manager 650 is capable of, configured to, or operable to support a means for transmitting, to the network entity, control signaling requesting reordering window statistics associated with the first set of multiple packets, where the reordering window statistics include at least one of a quantity of reorder timer starts, a quantity of duplicated packets, or a quantity of out of window packets.

In some examples, the one or more metrics include at least one of a quantity of duplicated packets associated with the first set of multiple packets, a quantity of out of window packets associated with the first set of multiple packets, a quantity of reordering timer starts associated with the first set of multiple packets.

In some examples, the one or more metrics include at least one of a hybrid automatic repeat request block error rate associated with the first set of multiple packets, a radio link control automatic repeat request block error rate associated with the first set of multiple packets, a quality of service characteristic associated with the first set of multiple packets, or a delay budget associated with the first set of multiple packets.

In some examples, the one or more metrics include at least one of a requirement associated with a packet data unit set budget delay, a packet data unit set error rate, or packet data unit set integrated handling information.

In some examples, the one or more metrics include a power metric associated with the first set of multiple packets. In some examples, the power metric is associated with a duty cycle.

In some examples, the one or more metrics include at least one of a quantity of duplicated packets communicated via one of the one or more communication links, or a quantity of out of window packets of the one of the one or more communication links.

In some examples, the machine learning model manager 655 is capable of, configured to, or operable to support a means for inputting to a machine learning model the one or more metrics associated with the first set of multiple packets, where an output of the machine learning model includes an indication to enable, disable, or modify the duplication. In some examples, the feedback manager 640 is capable of, configured to, or operable to support a means for transmitting the message requesting to enable, disable, or modify the duplication based on the output of the machine learning model.

In some examples, the machine learning model manager 655 is capable of, configured to, or operable to support a means for inputting to a machine learning model the one or more metrics associated with the first set of multiple packets, where the machine learning model provides an output related to the duplication. In some examples, the duplication manager 645 is capable of, configured to, or operable to support a means for modifying a value for a reordering timer or a duplication percentage based on the output of the machine learning model.

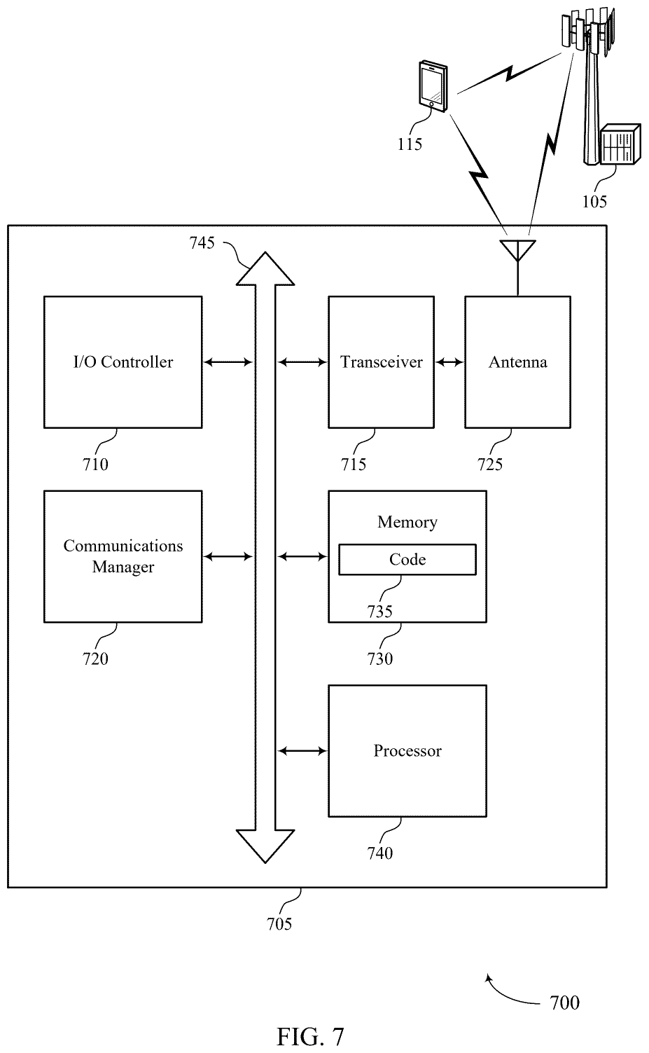

FIG. 7 shows a diagram of a system 700 including a device 705 that supports techniques for adaptive PDCP duplication in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for adaptive PDCP duplication). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for establishing one or more communication links with a network entity, where each communication link includes a respective bearer. The communications manager 720 is capable of, configured to, or operable to support a means for communicating, with the network entity, a first set of multiple packets via the one or more communication links. The communications manager 720 is capable of, configured to, or operable to support a means for monitoring one or more metrics associated with the first set of multiple packets. The communications manager 720 is capable of, configured to, or operable to support a means for transmitting, to the network entity, a message associated with configuration of PDCP duplication on the respective bearers of one or more of a second set of multiple packets to be communicated via the one or more communication links, where the message is based on the one or more metrics.

By including or configuring the communications manager 720 in accordance with examples as described herein, the device 705 may support techniques for reduced latency, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for adaptive PDCP duplication as described herein, or the at least one processor 740 and the at least one memory 730 may be otherwise configured to, individually or collectively, perform or support such operations.

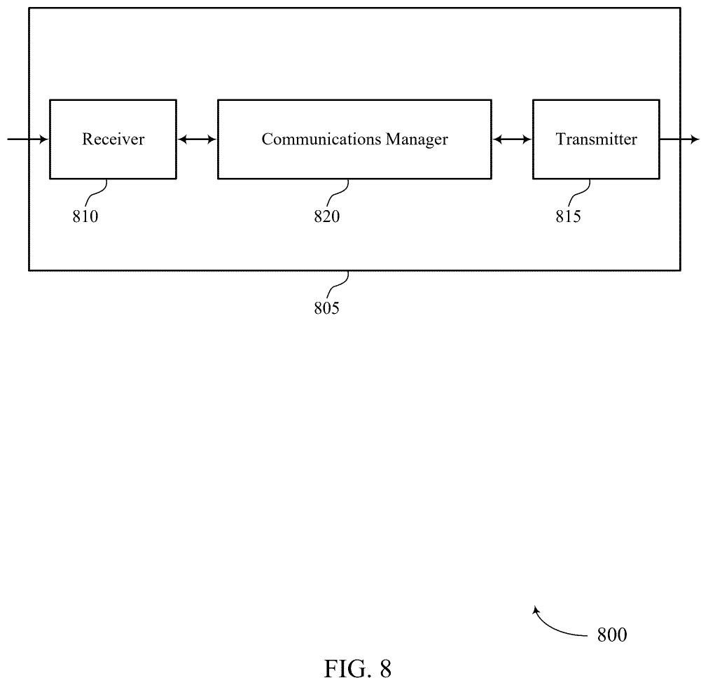

FIG. 8 shows a block diagram 800 of a device 805 that supports techniques for adaptive PDCP duplication in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for adaptive PDCP duplication as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for establishing one or more communication links with a UE, where each communication link includes a respective bearer. The communications manager 820 is capable of, configured to, or operable to support a means for communicating, with the UE, a first set of multiple packets via the one or more communication links. The communications manager 820 is capable of, configured to, or operable to support a means for obtaining, from the UE, a message associated with configuration of PDCP duplication on the respective bearers of one or more of a second set of multiple packets to be communicated via the one or more communication links.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

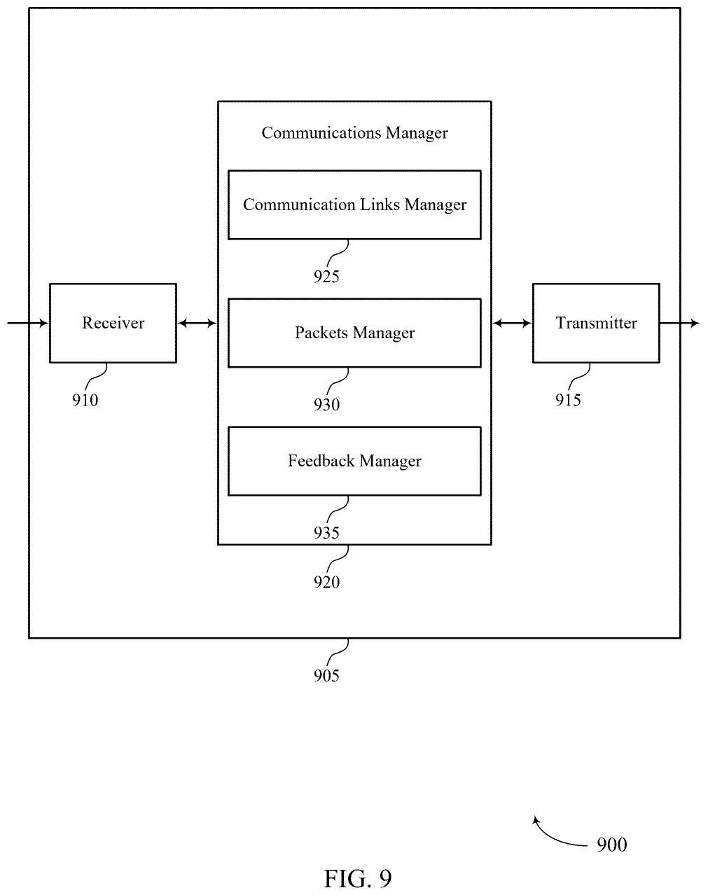

FIG. 9 shows a block diagram 900 of a device 905 that supports techniques for adaptive PDCP duplication in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for adaptive PDCP duplication as described herein. For example, the communications manager 920 may include a communication links manager 925, a packets manager 930, a feedback manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The communication links manager 925 is capable of, configured to, or operable to support a means for establishing one or more communication links with a UE, where each communication link includes a respective bearer. The packets manager 930 is capable of, configured to, or operable to support a means for communicating, with the UE, a first set of multiple packets via the one or more communication links. The feedback manager 935 is capable of, configured to, or operable to support a means for obtaining, from the UE, a message associated with configuration of PDCP duplication on the respective bearers of one or more of a second set of multiple packets to be communicated via the one or more communication links.

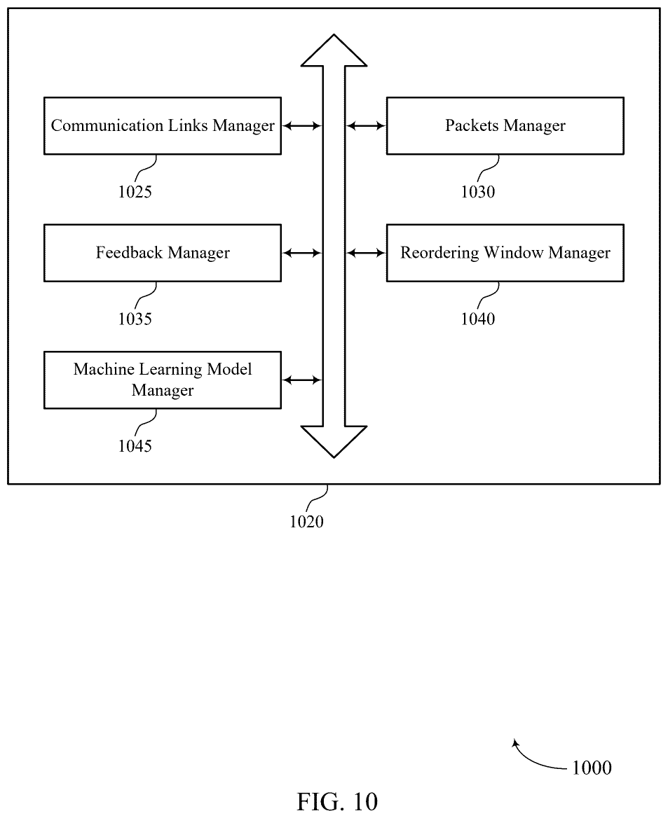

FIG. 10 shows a block diagram 1000 of a communications manager 1020 that supports techniques for adaptive PDCP duplication in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for adaptive PDCP duplication as described herein. For example, the communications manager 1020 may include a communication links manager 1025, a packets manager 1030, a feedback manager 1035, a reordering window manager 1040, a machine learning model manager 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The communication links manager 1025 is capable of, configured to, or operable to support a means for establishing one or more communication links with a UE, where each communication link includes a respective bearer. The packets manager 1030 is capable of, configured to, or operable to support a means for communicating, with the UE, a first set of multiple packets via the one or more communication links. The feedback manager 1035 is capable of, configured to, or operable to support a means for obtaining, from the UE, a message associated with configuration of PDCP duplication on the respective bearers of one or more of a second set of multiple packets to be communicated via the one or more communication links.

In some examples, to support obtaining the message, the feedback manager 1035 is capable of, configured to, or operable to support a means for obtaining the message indicating that the UE enables, disables, or modifies the duplication based on at least one of a packet error based metric or a packet latency based metric.

In some examples, to support obtaining the message, the feedback manager 1035 is capable of, configured to, or operable to support a means for obtaining the message requesting to enable, disable, or modify the duplication based on at least one of a packet error associated with a reordering window of the UE or a recovery latency associated with a reordering window of the UE.

In some examples, to support obtaining the message, the feedback manager 1035 is capable of, configured to, or operable to support a means for obtaining the message indicating a quantity of duplicated packets associated with the first set of multiple packets, a quantity of out of window packets associated with the first set of multiple packets, or both.

In some examples, the packets manager 1030 is capable of, configured to, or operable to support a means for scheduling the second set of multiple packets based on the message.

In some examples, the reordering window manager 1040 is capable of, configured to, or operable to support a means for obtaining, from the UE, control signaling requesting reordering window statistics associated with the first set of multiple packets, where the reordering window statistics include at least one of a quantity of reorder timer starts associated with the first set of multiple packets, a quantity of duplicated packets associated with the first set of multiple packets, or a quantity of out of window packets associated with the first set of multiple packets.

In some examples, the machine learning model manager 1045 is capable of, configured to, or operable to support a means for inputting to a machine learning model one or more metrics associated with the first set of multiple packets, where an output of the machine learning model includes an indicator to enable, disable, or modify the duplication.

In some examples, the machine learning model manager 1045 is capable of, configured to, or operable to support a means for inputting to a machine learning model one or more metrics associated with the first set of multiple packets, where the machine learning model provides an output related to the duplication. In some examples, the packets manager 1030 is capable of, configured to, or operable to support a means for scheduling the second set of multiple packets based on the output of the machine learning model.

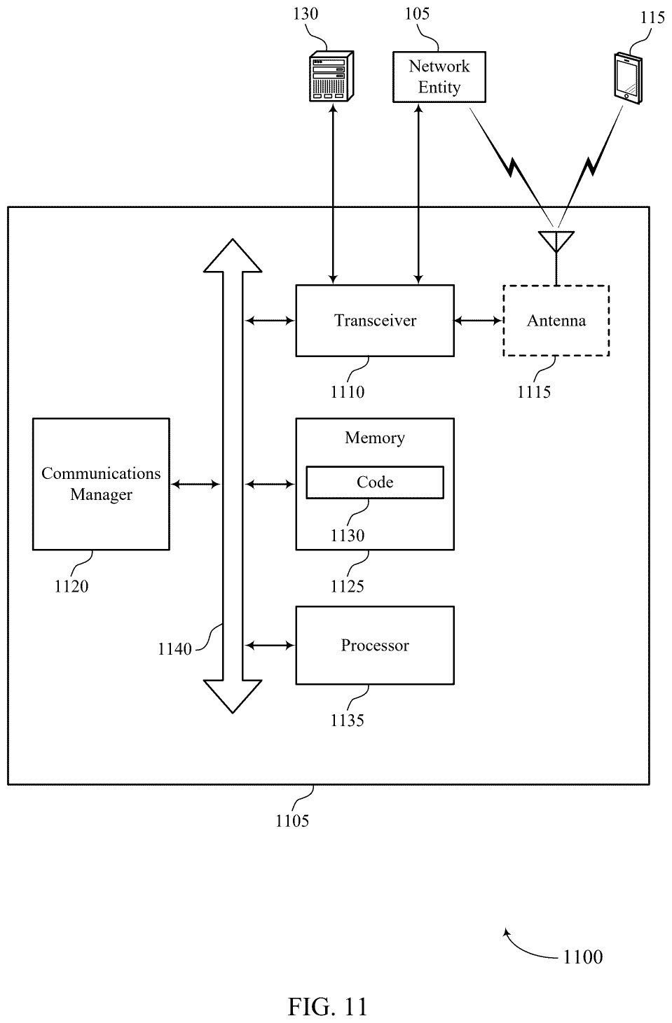

FIG. 11 shows a diagram of a system 1100 including a device 1105 that supports techniques for adaptive PDCP duplication in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for adaptive PDCP duplication). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for establishing one or more communication links with a UE, where each communication link includes a respective bearer. The communications manager 1120 is capable of, configured to, or operable to support a means for communicating, with the UE, a first set of multiple packets via the one or more communication links. The communications manager 1120 is capable of, configured to, or operable to support a means for obtaining, from the UE, a message associated with configuration of PDCP duplication on the respective bearers of one or more of a second set of multiple packets to be communicated via the one or more communication links.

By including or configuring the communications manager 1120 in accordance with examples as described herein, the device 1105 may support techniques for reduced latency, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for adaptive PDCP duplication as described herein, or the at least one processor 1135 and the at least one memory 1125 may be otherwise configured to, individually or collectively, perform or support such operations.

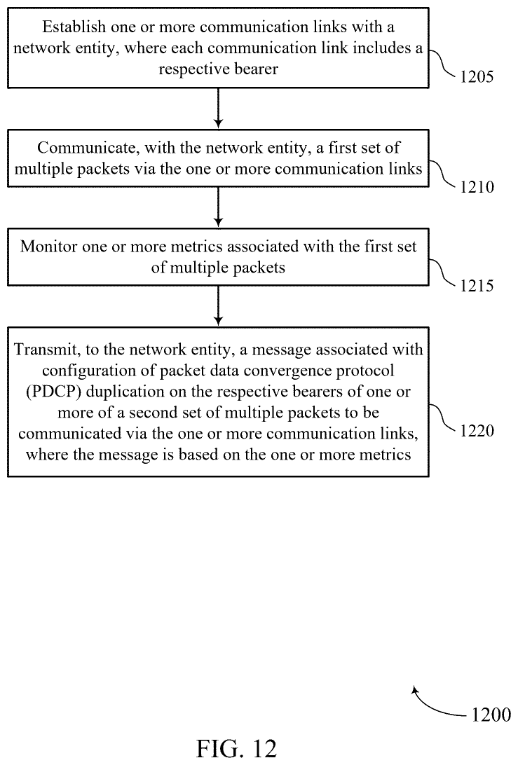

FIG. 12 shows a flowchart illustrating a method 1200 that supports techniques for adaptive PDCP duplication in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include establishing one or more communication links with a network entity, where each communication link includes a respective bearer. The operations of 1205 may be performed in accordance with examples as disclosed herein. In some examples, aspects of the operations of 1205 may be performed by a communication links manager 625 as described with reference to FIG. 6.

At 1210, the method may include communicating, with the network entity, a first set of multiple packets via the one or more communication links. The operations of 1210 may be performed in accordance with examples as disclosed herein. In some examples, aspects of the operations of 1210 may be performed by a packets manager 630 as described with reference to FIG. 6.

At 1215, the method may include monitoring one or more metrics associated with the first set of multiple packets. The operations of 1215 may be performed in accordance with examples as disclosed herein. In some examples, aspects of the operations of 1215 may be performed by a metrics manager 635 as described with reference to FIG. 6.

At 1220, the method may include transmitting, to the network entity, a message associated with configuration of PDCP duplication on the respective bearers of one or more of a second set of multiple packets to be communicated via the one or more communication links, where the message is based on the one or more metrics. The operations of 1220 may be performed in accordance with examples as disclosed herein. In some examples, aspects of the operations of 1220 may be performed by a feedback manager 640 as described with reference to FIG. 6.

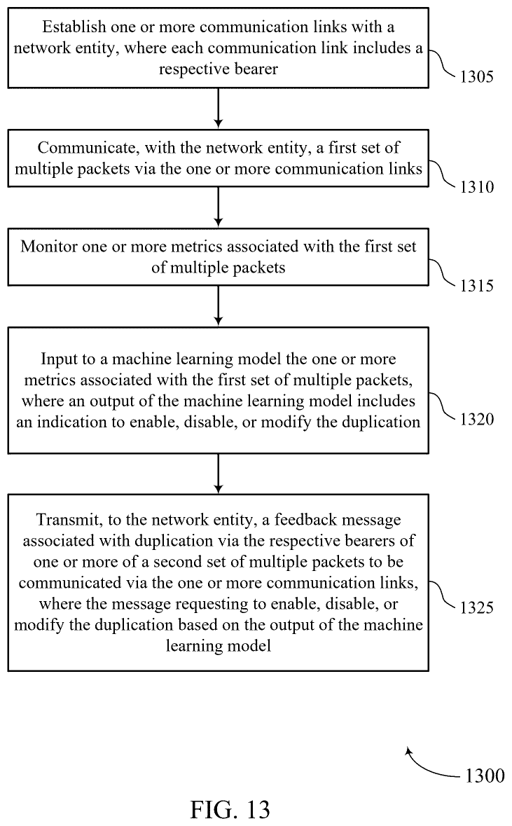

FIG. 13 shows a flowchart illustrating a method 1300 that supports techniques for adaptive PDCP duplication in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include establishing one or more communication links with a network entity, where each communication link includes a respective bearer. The operations of 1305 may be performed in accordance with examples as disclosed herein. In some examples, aspects of the operations of 1305 may be performed by a communication links manager 625 as described with reference to FIG. 6.

At 1310, the method may include communicating, with the network entity, a first set of multiple packets via the one or more communication links. The operations of 1310 may be performed in accordance with examples as disclosed herein. In some examples, aspects of the operations of 1310 may be performed by a packets manager 630 as described with reference to FIG. 6.

At 1315, the method may include monitoring one or more metrics associated with the first set of multiple packets. The operations of 1315 may be performed in accordance with examples as disclosed herein. In some examples, aspects of the operations of 1315 may be performed by a metrics manager 635 as described with reference to FIG. 6.

At 1320, the method may include inputting to a machine learning model the one or more metrics associated with the first set of multiple packets, where an output of the machine learning model includes an indication to enable, disable, or modify the duplication; and. The operations of 1320 may be performed in accordance with examples as disclosed herein. In some examples, aspects of the operations of 1320 may be performed by a machine learning model manager 655 as described with reference to FIG. 6.

At 1325, the method may include where, to transmit the message, the one or more processors are individually or collectively further operable to execute the code to cause the UE to. The operations of 1325 may be performed in accordance with examples as disclosed herein. In some examples, aspects of the operations of 1325 may be performed by a feedback manager 640 as described with reference to FIG. 6.

At 1330, the method may include transmit the message requesting to enable, disable, or modify the duplication based on the output of the machine learning model. The operations of 1330 may be performed in accordance with examples as disclosed herein. In some examples, aspects of the operations of 1330 may be performed by a feedback manager 640 as described with reference to FIG. 6.

At 1335, the method may include transmitting, to the network entity, a message associated with configuration of PDCP duplication on the respective bearers of one or more of a second set of multiple packets to be communicated via the one or more communication links, where the message is based on the one or more metrics. The operations of 1335 may be performed in accordance with examples as disclosed herein. In some examples, aspects of the operations of 1335 may be performed by a feedback manager 640 as described with reference to FIG. 6.

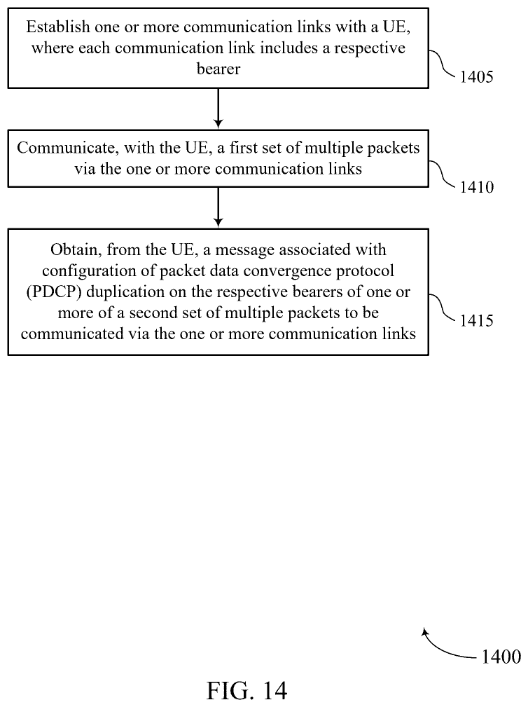

FIG. 14 shows a flowchart illustrating a method 1400 that supports techniques for adaptive PDCP duplication in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include establishing one or more communication links with a UE, where each communication link includes a respective bearer. The operations of 1405 may be performed in accordance with examples as disclosed herein. In some examples, aspects of the operations of 1405 may be performed by a communication links manager 1025 as described with reference to FIG. 10.

At 1410, the method may include communicating, with the UE, a first set of multiple packets via the one or more communication links. The operations of 1410 may be performed in accordance with examples as disclosed herein. In some examples, aspects of the operations of 1410 may be performed by a packets manager 1030 as described with reference to FIG. 10.

At 1415, the method may include obtaining, from the UE, a message associated with configuration of PDCP duplication on the respective bearers of one or more of a second set of multiple packets to be communicated via the one or more communication links. The operations of 1415 may be performed in accordance with examples as disclosed herein. In some examples, aspects of the operations of 1415 may be performed by a feedback manager 1035 as described with reference to FIG. 10.

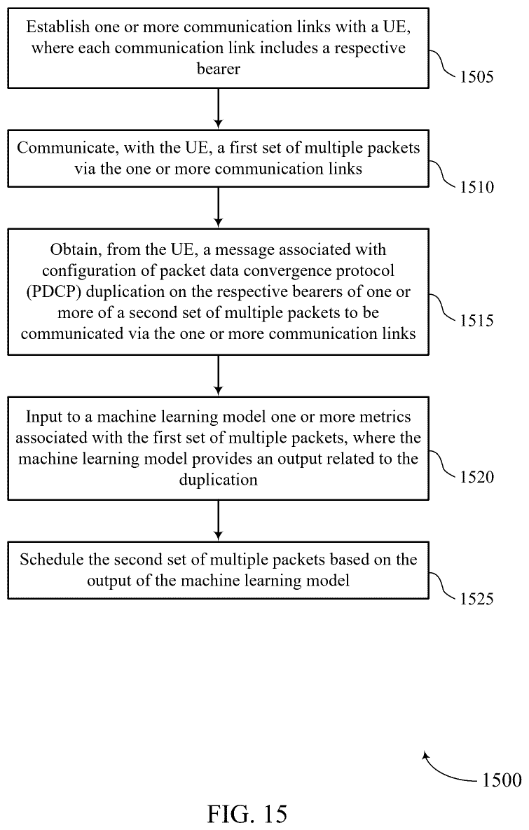

FIG. 15 shows a flowchart illustrating a method 1500 that supports techniques for adaptive PDCP duplication in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include establishing one or more communication links with a UE, where each communication link includes a respective bearer. The operations of 1505 may be performed in accordance with examples as disclosed herein. In some examples, aspects of the operations of 1505 may be performed by a communication links manager 1025 as described with reference to FIG. 10.

At 1510, the method may include communicating, with the UE, a first set of multiple packets via the one or more communication links. The operations of 1510 may be performed in accordance with examples as disclosed herein. In some examples, aspects of the operations of 1510 may be performed by a packets manager 1030 as described with reference to FIG. 10.

At 1515, the method may include obtaining, from the UE, a message associated with configuration of PDCP duplication on the respective bearers of one or more of a second set of multiple packets to be communicated via the one or more communication links. The operations of 1515 may be performed in accordance with examples as disclosed herein. In some examples, aspects of the operations of 1515 may be performed by a feedback manager 1035 as described with reference to FIG. 10.

At 1520, the method may include inputting to a machine learning model one or more metrics associated with the first set of multiple packets, where the machine learning model provides an output related to the duplication. The operations of 1520 may be performed in accordance with examples as disclosed herein. In some examples, aspects of the operations of 1520 may be performed by a machine learning model manager 1045 as described with reference to FIG. 10.

At 1525, the method may include scheduling the second set of multiple packets based on the output of the machine learning model. The operations of 1525 may be performed in accordance with examples as disclosed herein. In some examples, aspects of the operations of 1525 may be performed by a packets manager 1030 as described with reference to FIG. 10.

The following provides an overview of aspects of the present disclosure:
Aspect 1: A method for wireless communication by a UE, comprising: establishing one or more communication links with a network entity, wherein each communication link comprises a respective bearer; communicating, with the network entity, a first plurality of packets via the one or more communication links; monitoring one or more metrics associated with the first plurality of packets; and transmitting, to the network entity, a message associated with configuration of PDCP duplication on the respective bearers of one or more of a second plurality of packets to be communicated via the one or more communication links, wherein the message is based at least in part on the one or more metrics.
Aspect 2: The method of aspect 1, wherein monitoring the one or more metrics further comprises: determining whether to enable, disable, or modify the duplication based at least in part on the one or more metrics, wherein the one or more metrics comprise at least one of a packet error based metric or packet latency based metric.
Aspect 3: The method of aspect 1, wherein transmitting the message further comprises: transmitting the message requesting to enable, disable, or modify the duplication based at least in part on the one or more metrics, wherein the one or more metrics comprise at least one of a packet error associated with a reordering window or a recovery latency associated with the reordering window.
Aspect 4: The method of aspect 1, wherein transmitting the message comprises: transmitting the message indicating a quantity of duplicated packets of the first plurality of packets, a quantity of out of window packets of the first plurality of packets, or both.
Aspect 5: The method of aspect 4, wherein the message is transmitted periodically.
Aspect 6: The method of aspect 1, wherein the one or more communication links comprise a plurality of communication links, and the message indicates to duplicate the one or more of the second plurality of packets across the respective bearers of the plurality of communication links.
Aspect 7: The method of aspect 1, wherein the message is transmitted based on an event associated with the duplication.
Aspect 8: The method of aspect 1, further comprising: transmitting, to the network entity, control signaling requesting reordering window statistics associated with the first plurality of packets, wherein the reordering window statistics comprise at least one of a quantity of reorder timer starts, a quantity of duplicated packets, or a quantity of out of window packets.
Aspect 9: The method of aspect 1, wherein the one or more metrics comprise at least one of a quantity of duplicated packets associated with the first plurality of packets, a quantity of out of window packets associated with the first plurality of packets, a quantity of reordering timer starts associated with the first plurality of packets.
Aspect 10: The method of aspect 1, wherein the one or more metrics comprise at least one of a hybrid automatic repeat request block error rate associated with the first plurality of packets, a radio link control automatic repeat request block error rate associated with the first plurality of packets, a quality of service characteristic associated with the first plurality of packets, or a delay budget associated with the first plurality of packets.
Aspect 11: The method of aspect 1, wherein the one or more metrics comprise at least one of a requirement associated with a packet data unit set budget delay, a packet data unit set error rate, or packet data unit set integrated handling information.
Aspect 12: The method of aspect 1, wherein the one or more metrics comprise a power metric associated with the first plurality of packets, the power metric is associated with a duty cycle.
Aspect 13: The method of aspect 1, wherein the one or more metrics comprise at least one of a quantity of duplicated packets communicated via one of the one or more communication links, or a quantity of out of window packets of the one of the one or more communication links.
Aspect 14: The method of aspect 1, further comprising: inputting to a machine learning model the one or more metrics associated with the first plurality of packets, wherein an output of the machine learning model comprises an indication to enable, disable, or modify the duplication; and. wherein, to transmit the message, the one or more processors are individually or collectively further operable to execute the code to cause the UE to: transmit the message requesting to enable, disable, or modify the duplication based at least in part on the output of the machine learning model.
Aspect 15: The method of aspect 1, further comprising: inputting to a machine learning model the one or more metrics associated with the first plurality of packets, wherein the machine learning model provides an output related to the duplication; and modifying a value for a reordering timer or a duplication percentage based at least in part on the output of the machine learning model.
Aspect 16: A method for wireless communication by a network entity, comprising: establishing one or more communication links with a UE, wherein each communication link comprises a respective bearer; communicating, with the UE, a first plurality of packets via the one or more communication links; and obtaining, from the UE, a message associated with configuration of PDCP duplication on the respective bearers of one or more of a second plurality of packets to be communicated via the one or more communication links.
Aspect 17: The method of aspect 16, wherein obtaining the message comprises: obtaining the message indicating that the UE enables, disables, or modifies the duplication based at least in part on at least one of a packet error based metric or a packet latency based metric.
Aspect 18: The method of aspect 16, wherein obtaining the message further comprises: obtaining the message requesting to enable, disable, or modify the duplication based at least in part on at least one of a packet error associated with a reordering window of the UE or a recovery latency associated with a reordering window of the UE.
Aspect 19: The method of aspect 16, wherein obtaining the message further comprises: obtaining the message indicating a quantity of duplicated packets associated with the first plurality of packets, a quantity of out of window packets associated with the first plurality of packets, or both.
Aspect 20: The method of aspect 19, further comprising: scheduling the second plurality of packets based at least in part on the message.
Aspect 21: The method of 16, further comprising: obtaining, from the UE, control signaling requesting reordering window statistics associated with the first plurality of packets, wherein the reordering window statistics comprise at least one of a quantity of reorder timer starts associated with the first plurality of packets, a quantity of duplicated packets associated with the first plurality of packets, or a quantity of out of window packets associated with the first plurality of packets.
Aspect 22: The method of aspect 16, further comprising: inputting to a machine learning model one or more metrics associated with the first plurality of packets, wherein an output of the machine learning model comprises an indicator to enable, disable, or modify the duplication.
Aspect 23: The method of aspect 16, further comprising: inputting to a machine learning model one or more metrics associated with the first plurality of packets, wherein the machine learning model provides an output related to the duplication; and scheduling the second plurality of packets based at least in part on the output of the machine learning model.
Aspect 24: A UE for wireless communication, comprising one or more memories storing processor-executable code, and one or more processors coupled with the one or more memories and individually or collectively operable to execute the code to cause the UE to perform a method of any of aspects 1 through 15.
Aspect 25: A UE for wireless communication, comprising at least one means for performing a method of any of aspects 1 through 15.
Aspect 26: A non-transitory computer-readable medium storing code for wireless communication, the code comprising instructions executable by one or more processors to perform a method of any of aspects 1 through 15.
Aspect 27: A network entity for wireless communication, comprising one or more memories storing processor-executable code, and one or more processors coupled with the one or more memories and individually or collectively operable to execute the code to cause the network entity to perform a method of any of aspects 16 through 23.
Aspect 28: A network entity for wireless communication, comprising at least one means for performing a method of any of aspects 16 through 23.
Aspect 29: A non-transitory computer-readable medium storing code for wireless communication, the code comprising instructions executable by one or more processors to perform a method of any of aspects 16 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
establish one or more communication links with a network entity, wherein each communication link comprises a respective bearer;
communicate, with the network entity, a first plurality of packets via the one or more communication links;
monitor one or more metrics associated with the first plurality of packets; and
transmit, to the network entity, a message associated with configuration of packet data convergence protocol (PDCP) duplication on the respective bearers of one or more of a second plurality of packets to be communicated via the one or more communication links, wherein the message is based at least in part on the one or more metrics.

2. The UE of claim 1, wherein the one or more processors are individually or collectively further operable to execute the code to cause the UE to:
input to a machine learning model the one or more metrics associated with the first plurality of packets, wherein an output of the machine learning model comprises an indication to enable, disable, or modify the duplication; and
wherein, to transmit the message, the one or more processors are individually or collectively further operable to execute the code to cause the UE to:
transmit the message requesting to enable, disable, or modify the duplication based at least in part on the output of the machine learning model.

3. The UE of claim 1, wherein the one or more processors are individually or collectively further operable to execute the code to cause the UE to:
input to a machine learning model the one or more metrics associated with the first plurality of packets, wherein the machine learning model provides an output related to the duplication; and
modify a value for a reordering timer or a duplication percentage based at least in part on the output of the machine learning model.

4. The UE of claim 1, wherein, to monitor the one or more metrics, the one or more processors are individually or collectively further operable to execute the code to cause the UE to:
determine whether to enable, disable, or modify the duplication based at least in part on the one or more metrics, wherein the one or more metrics comprise at least one of a packet error based metric or packet latency based metric.

5. The UE of claim 1, wherein, to transmit the message, the one or more processors are individually or collectively further operable to execute the code to cause the UE to:
transmit the message requesting to enable, disable, or modify the duplication based at least in part on the one or more metrics, wherein the one or more metrics comprise at least one of a packet error associated with a reordering window or a recovery latency associated with the reordering window.

6. The UE of claim 1, wherein, to transmit the message, the one or more processors are individually or collectively operable to execute the code to cause the UE to:
transmit the message indicating a quantity of duplicated packets of the first plurality of packets, a quantity of out of window packets of the first plurality of packets, or both.

7. The UE of claim 6, wherein:
the message is transmitted periodically.

8. The UE of claim 1, wherein:
the one or more communication links comprise a plurality of communication links, and
the message indicates to duplicate the one or more of the second plurality of packets across the respective bearers of the plurality of communication links.

9. The UE of claim 1, wherein the message is transmitted based on an event associated with the duplication.

10. The UE of claim 1, wherein the one or more processors are individually or collectively further operable to execute the code to cause the UE to:
transmit, to the network entity, control signaling requesting reordering window statistics associated with the first plurality of packets, wherein the reordering window statistics comprise at least one of a quantity of reorder timer starts, a quantity of duplicated packets, or a quantity of out of window packets.

11. The UE of claim 1, wherein the one or more metrics comprise at least one of a quantity of duplicated packets associated with the first plurality of packets, a quantity of out of window packets associated with the first plurality of packets, a quantity of reordering timer starts associated with the first plurality of packets.

12. The UE of claim 1, wherein the one or more metrics comprise at least one of a hybrid automatic repeat request block error rate associated with the first plurality of packets, a radio link control automatic repeat request block error rate associated with the first plurality of packets, a quality of service characteristic associated with the first plurality of packets, or a delay budget associated with the first plurality of packets.

13. The UE of claim 1, wherein the one or more metrics comprise at least one of a requirement associated with a packet data unit set budget delay, a packet data unit set error rate, or packet data unit set integrated handling information.

14. The UE of claim 1, wherein:
the one or more metrics comprise a power metric associated with the first plurality of packets, and
the power metric is associated with a duty cycle.

15. The UE of claim 1, wherein the one or more metrics comprise at least one of a quantity of duplicated packets communicated via one of the one or more communication links, or a quantity of out of window packets of the one of the one or more communication links.

16. A network entity, comprising:
one or more memories storing processor-executable code; and
one or more processors coupled with the one or more memories and individually or collectively operable to execute the code to cause the network entity to:
establish one or more communication links with a user equipment (UE), wherein each communication link comprises a respective bearer;
communicate, with the UE, a first plurality of packets via the one or more communication links; and
obtain, from the UE, a message associated with configuration of packet data convergence protocol (PDCP) duplication on the respective bearers of one or more of a second plurality of packets to be communicated via the one or more communication links.

17. The network entity of claim 16, wherein the one or more processors are individually or collectively further operable to execute the code to cause the network entity to:
input to a machine learning model one or more metrics associated with the first plurality of packets, wherein an output of the machine learning model comprises an indicator to enable, disable, or modify the duplication.

18. The network entity of claim 16, wherein the one or more processors are individually or collectively further operable to execute the code to cause the network entity to:
input to a machine learning model one or more metrics associated with the first plurality of packets, wherein the machine learning model provides an output related to the duplication; and
schedule the second plurality of packets based at least in part on the output of the machine learning model.

19. The network entity of claim 16, wherein, to obtain the message, the one or more processors are individually or collectively operable to execute the code to cause the network entity to:
obtain the message indicating that the UE enables, disables, or modifies the duplication based at least in part on at least one of a packet error based metric or a packet latency based metric.

20. The network entity of claim 16, wherein, to obtain the message, the one or more processors are individually or collectively further operable to execute the code to cause the network entity to:
obtain the message requesting to enable, disable, or modify the duplication based at least in part on at least one of a packet error associated with a reordering window of the UE or a recovery latency associated with a reordering window of the UE.

21. The network entity of claim 16, wherein, to obtain the message, the one or more processors are individually or collectively further operable to execute the code to cause the network entity to:
obtain the message indicating a quantity of duplicated packets associated with the first plurality of packets, a quantity of out of window packets associated with the first plurality of packets, or both.

22. The network entity of claim 21, wherein the one or more processors are individually or collectively further operable to execute the code to cause the network entity to:
schedule the second plurality of packets based at least in part on the message.

23. The network entity of claim 16, wherein the one or more processors are individually or collectively further operable to execute the code to cause the network entity to:
obtain, from the UE, control signaling requesting reordering window statistics associated with the first plurality of packets, wherein the reordering window statistics comprise at least one of a quantity of reorder timer starts associated with the first plurality of packets, a quantity of duplicated packets associated with the first plurality of packets, or a quantity of out of window packets associated with the first plurality of packets.

24. A method for wireless communication by a user equipment (UE), comprising:
establishing one or more communication links with a network entity, wherein each communication link comprises a respective bearer;
communicating, with the network entity, a first plurality of packets via the one or more communication links;
monitoring one or more metrics associated with the first plurality of packets; and
transmitting, to the network entity, a message associated with configuration of packet data convergence protocol (PDCP) duplication on the respective bearers of one or more of a second plurality of packets to be communicated via the one or more communication links, wherein the message is based at least in part on the one or more metrics.

25. The method of claim 24, further comprising:
inputting to a machine learning model the one or more metrics associated with the first plurality of packets, wherein an output of the machine learning model comprises an indication to enable, disable, or modify the duplication; and
wherein, transmitting the message further comprises:
transmitting the message requesting to enable, disable, or modify the duplication based at least in part on the output of the machine learning model.

26. The method of claim 24, further comprising:
inputting to a machine learning model the one or more metrics associated with the first plurality of packets, wherein the machine learning model provides an output related to the duplication; and
modifying a value for a reordering timer or a duplication percentage based at least in part on the output of the machine learning model.

27. The method of claim 24, wherein monitoring the one or more metrics further comprises:
determining whether to enable, disable, or modify the duplication based at least in part on the one or more metrics, wherein the one or more metrics comprise at least one of a packet error based metric or packet latency based metric.

28. A method for wireless communication by a network entity, comprising:
establishing one or more communication links with a user equipment (UE), wherein each communication link comprises a respective bearer;
communicating, with the UE, a first plurality of packets via the one or more communication links; and
obtaining, from the UE, a message associated with configuration of packet data convergence protocol (PDCP) duplication on the respective bearers of one or more of a second plurality of packets to be communicated via the one or more communication links.

29. The method of claim 28, further comprising:
inputting to a machine learning model one or more metrics associated with the first plurality of packets, wherein an output of the machine learning model comprises an indicator to enable, disable, or modify the duplication.

30. The method of claim 28, further comprising:
inputting to a machine learning model one or more metrics associated with the first plurality of packets, wherein the machine learning model provides an output related to the duplication; and
scheduling the second plurality of packets based at least in part on the output of the machine learning model.
